(19) United States
(12) Patent Application Publication
(10) Pub. No.: US 2020/0139687 A1
(43) Pub. Date: May 7, 2020

(54) MULTILAYER CURABLE ARTICLES

(71) Applicant: Saint-Gobain Performance Plastics Corporation, Solon, OH (US)

(72) Inventors: Jianfeng Zhang, Shrewsbury, MA (US); Jian L. Ding, Glastonbury, CT (US); Michael J. Tzivanis, Chicopee, MA (US); Adam P. Nadeau, Boylston, MA (US); Xipeng Liu, Concord, MA (US)

(21) Appl. No.: 16/670,904

(22) Filed: Oct. 31, 2019

Related U.S. Application Data
(60) Provisional application No. 62/753,785, filed on Oct. 31, 2018.

(51) Int. Cl. B32B 27/08; B32B 1/08; B32B 27/28; B32B 9/04; B01J 23/42; B01J 23/44; B32B 27/32; B32B 25/18; B32B 25/16

(52) U.S. Cl. CPC B32B 27/08; B32B 1/08; B32B 27/285; B32B 9/043; B01J 23/42; C08K 5/5419; B32B 27/283; B32B 27/322; B32B 25/18; B32B 25/16; B01J 23/44

(57) ABSTRACT

The present disclosure relates to articles comprising first and second layers, each layer including a cross-linkable polymer and a cross-linker, to methods for preparing and curing such articles, and to articles formed thereby. In one aspect, the disclosure provides a curable article including a first layer including a first cross-linkable polymer comprising at least about two unsaturated carbon bonds, a first cross-linker comprising at least about two silicon-hydride functional groups, present in the first layer in an amount within the range of 0.1 wt. % to 20 wt. %, and a first hydrosilylation catalyst; and a second layer in contact with the first layer, the second layer comprising a second cross-linkable polymer comprising at least about two unsaturated carbon bonds, a second cross-linker comprising at least about two silicon-hydride functional groups, and a second hydrosilylation catalyst. The second layer does not include a substantial amount of the first cross-linkable polymer.

### CROSS-REFERENCE TO RELATED APPLICATIONS

This application claims the benefit of priority of U.S. Provisional Patent Application No. 62/753785, filed Oct. 31, 2018, which is hereby incorporated herein by reference in its entirety.

### BACKGROUND OF THE DISCLOSURE

### Field of the Disclosure

This disclosure relates generally to curable articles. More particularly, the present disclosure relates to articles comprising a first layer and a second layer, each layer including a cross-linkable polymer and a cross-linker, to methods for preparing and curing such articles, and to articles formed thereby.

### Technical Background

Silicones, also known as polysiloxanes, are polymers made up of repeating siloxane units (—SiR₂—O—) in which each R can be any of a wide variety of substituents. Silicones are widely used in industry because silicone articles can be non-toxic, flexible, and thermally stable. Moreover, silicones can have low chemical reactivity, and silicone articles can be produced in a variety of shapes and sizes. For example, silicone tubing is popular in industries including medicine, pharmaceuticals, and food delivery.

However, many of the physical properties of silicones, such as coefficient of friction, tack, and permeability, can be unsuitable for certain applications. Composite articles including layers of silicone together with other materials (e.g., thermosetting plastics, elastomers, etc.) can address such limitations, but conventional methods for bonding silicone to dissimilar materials are complicated and time consuming, typically involving surface treatments and/or priming processes. Moreover, articles provided by such processes can still exhibit poor interfacial adhesion. Conventional methods for forming composite articles involve applying heat-curing silicone materials to separately cured polymer layers at elevated temperatures (e.g., in excess of 160° C.), which requires costly, high-melt-temperature materials.

Accordingly, there remains a need for multilayer articles that have improved interfacial adhesion and/or can be prepared efficiently (e.g., UV- or low-temperature-cured, and/or co-cured).

### SUMMARY OF THE DISCLOSURE

One embodiment of the disclosure is a curable article including
a first layer having a first side and an opposed second side, the first layer comprising
   a first cross-linkable polymer comprising at least about two unsaturated carbon bonds, present in the first layer in an amount within the range of about 10 wt. % to about 99.9 wt. %,
      a first cross-linker comprising at least about two silicon-hydride functional groups, present in the first layer in an amount within the range of 0.1 wt. % to 20 wt. %, and
   an effective amount of a first hydrosilylation catalyst; and
a second layer having a first side disposed in contact with the first side of the first layer and an opposed second side, the second layer comprising
   a second cross-linkable polymer comprising at least about two unsaturated carbon bonds, present in the second layer in an amount within the range of 10 wt. % to 99.9 wt. %;
   a second cross-linker comprising at least about two silicon-hydride functional groups, present in an amount within the range of 0.1 wt. % to 20 wt. %; and
   an effective amount of a second hydrosilylation catalyst,
the second layer not including a substantial amount (e.g., no more than 5%, or no more than 3%, or no more than 2%) of the first cross-linkable polymer.

Another aspect of the disclosure is a method for preparing a cross-linked article, the method comprising providing a curable article as described herein, and curing the curable article.

Another aspect of the disclosure is a cross-linked article made by a method as described herein, or that is the cured product of a curable article as described herein.

### BRIEF DESCRIPTION OF THE DRAWINGS

FIG. 1 is a schematic cross-sectional view of a curable article according to one embodiment of the disclosure.

FIG. 2 is a schematic cross-sectional view of a curable article according to one embodiment of the disclosure.

FIG. 3 is a set of photographs of a cured article according to one embodiment of the disclosure.

### DETAILED DESCRIPTION

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice. Thus, before the disclosed processes and devices are described, it is to be understood that the aspects described herein are not limited to specific embodiments, apparati, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All methods described herein can be performed in any suitable order of steps unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, with a precision that is typical in the art.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

Terms used herein may be preceded and/or followed by a single dash, “—”, or a double dash, “═”, to indicate the bond order of the bond between the named substituent and its parent moiety; a single dash indicates a single bond and a double dash indicates a double bond or a pair of single bonds in the case of a spiro-substituent. In the absence of a single or double dash it is understood that a single bond is formed between the substituent and its parent moiety; further, substituents are intended to be read “left to right” unless a dash indicates otherwise. For example, arylalkyl, arylalkyl-, and -alkylaryl indicate the same functionality.

For simplicity, chemical moieties are defined and referred to throughout primarily as univalent chemical moieties (e.g., alkyl, aryl, etc.). Nevertheless, such terms are also used to convey corresponding multivalent moieties under the appropriate structural circumstances clear to those skilled in the art. For example, while an “alkyl” moiety can refer to a monovalent radical (e.g. CH₃—CH₂—), in some circumstances a bivalent linking moiety can be “alkyl,” in which case those skilled in the art will understand the alkyl to be a divalent radical (e.g., —CH₂—CH₂—), which is equivalent to the term “alkylene.” (Similarly, in circumstances in which a divalent moiety is required and is stated as being “aryl,” those skilled in the art will understand that the term “aryl” refers to the corresponding divalent moiety, arylene). All atoms are understood to have their normal number of valences for bond formation (i.e., 4 for carbon, 3 for N, 2 for O, and 2, 4, or 6 for S, depending on the oxidation state of the S). Nitrogens in the presently disclosed compounds can be hypervalent, e.g., an N-oxide or tetrasubstituted ammonium salt. On occasion a moiety may be defined, for example, as -B-(A)ₐ, wherein a is 0 or 1. In such instances, when a is 0 the moiety is −B and when a is 1 the moiety is -B-A.

As used herein, the term “hydrocarbon” includes linear hydrocarbons, branched hydrocarbons, acyclic hydrocarbons, alicyclic hydrocarbons, and aromatic hydrocarbons, including, for example, alkyl, alkoxy, alkenyl, alkynyl, aryl, heteroaryl, heterocycloalkyl, and cycloalkyl. The term “hydrocarbon” is applied to compounds that include heteroatoms, either as parts of cyclic structures, or as linkers within or substituents on the hydrocarbon group (e.g., as ethers, esters, amines, amides, sulfoxides, sulfonates and hydroxides)

As used herein, the term “alkyl” includes a saturated hydrocarbon having a designed number of carbon atoms, such as 1 to 12 carbons (i.e., inclusive of 1 and 12), 1 to 10 carbons, 1 to 8 carbons, 1 to 6 carbons, 1 to 3 carbons, or 1, 2, 3, 4, 5 or 6. Alkyl group may be straight or branched and depending on context, may be a monovalent radical or a divalent radical (i.e., an alkylene group). For example, the moiety “—(C₁-C₆alkyl)—O—” signifies connection of an oxygen through an alkylene bridge having from 1 to 6 carbons and C₁-C₃alkyl represents methyl, ethyl, and propyl moieties. Examples of “alkyl” include, for example, methyl, ethyl, propyl, isopropyl, butyl, iso-, sec-, and tert-butyl, pentyl, and hexyl.

The term “alkoxy” represents an alkyl group of an indicated number of carbon atoms attached to the parent molecular moiety through an oxygen bridge. Examples of “alkoxy” include, for example, methoxy, ethoxy, propoxy, and isopropoxy.

As used herein, the term “alkenyl” includes unsaturated hydrocarbons containing from 2 to 12 carbons (i.e., inclusive of 2 and 12), 2 to 10 carbons, 2 to 8 carbons, 2 to 6 carbons, or 2, 3, 4, 5, or 6, unless otherwise specified, and containing at least one carbon-carbon double bond. An alkenyl group may be straight or branched and depending on context, may be a monovalent radical or a divalent radical (i.e., an alkenylene group). For example, the moiety “—(C₂-C₆ alkenyl)—O—” signifies connection of an oxygen through an alkenylene bridge having from 2 to 6 carbons. Representative examples of alkenyl include, but are not limited to, ethenyl, 2-propenyl, 2-methyl-2-propenyl, 3-butenyl, 4-pentenyl, 5-hexenyl, 2-heptenyl, 2-methyl-1-heptenyl, 3-decenyl, and 3,7-dimethylocta-2,6-dienyl.

As used herein, the term “alkynyl” includes unsaturated hydrocarbons containing from 2 to 12 carbons (i.e., inclusive of 2 and 12), 2 to 10 carbons, 2 to 8 carbons, 2 to 6 carbons, or 2, 3, 4, 5, or 6, unless otherwise specified, and containing at least one carbon-carbon triple bond. An alkynyl group may be straight or branched and depending on context, may be a monovalent radical or a divalent radical (i.e., an alkynylene group). For example, the moiety “—(C₂-C₆ alkynyl)—O—” signifies connection of an oxygen through an alkynylene bridge having from 2 to 6 carbons. Representative examples of alkynyl include, but are not limited to, acetylenyl, 1-propynyl, 2-propynyl, 3-butynyl, 2-pentynyl, and 1-butynyl.

The term “aryl” represents an aromatic ring system having a single ring (e.g., phenyl) which is optionally fused to other aromatic hydrocarbon rings or non-aromatic hydrocarbon or heterocycle rings. “Aryl” includes ring systems having multiple condensed rings and in which at least one is carbocyclic and aromatic, (e.g., 1,2,3,4-tetrahydronaphthyl, naphthyl). Examples of aryl groups include phenyl, 1-naphthyl, 2-naphthyl, indanyl, indenyl, dihydronaphthyl, fluorenyl, tetralinyl, and 6,7,8,9-tetrahydro-5H-benzo[a]cycloheptenyl. “Aryl” also includes ring systems having a first carbocyclic, aromatic ring fused to a nonaromatic heterocycle, for example, 1H-2,3-dihydrobenzofuranyl and tetrahydroisoquinolinyl.

The terms “halogen” or “halo” indicate fluorine, chlorine, bromine, and iodine.

The term “heteroaryl” refers to an aromatic ring system containing at least one heteroatom selected from nitrogen, oxygen and sulfur. Most commonly, the heteroaryl groups will have 1, 2, 3, or 4 heteroatoms. The heteroaryl may be fused to one or more non-aromatic rings, for example, cycloalkyl or heterocycloalkyl rings, wherein the cycloalkyl and heterocycloalkyl rings are described herein. In one embodiment of the present compounds the heteroaryl group is bonded to the remainder of the structure through an atom in a heteroaryl group aromatic ring. In another embodiment, the heteroaryl group is bonded to the remainder of the structure through a non-aromatic ring atom. Examples of heteroaryl groups include, for example, pyridyl, pyrimidinyl, quinolinyl, benzothienyl, indolyl, indolinyl, pyridazinyl, pyrazinyl, isoindolyl, isoquinolyl, quinazolinyl, quinoxalinyl, phthalazinyl, imidazolyl, isoxazolyl, pyrazolyl, oxazolyl, thiazolyl, indolizinyl, indazolyl, benzothiazolyl, benzimidazolyl, benzofuranyl, furanyl, thienyl, pyrrolyl, oxadiazolyl, thiadiazolyl, benzo[1,4]oxazinyl, triazolyl, tetrazolyl, isothiazolyl, naphthyridinyl, isochromanyl, chromanyl, isoindolinyl, isobenzothienyl, benzoxazolyl, pyridopyridinyl, purinyl, benzodioxolyl, triazinyl, pteridinyl, benzothiazolyl, imidazopyridinyl, imidazothiazolyl, benzisoxazinyl, benzoxazinyl, benzopyranyl, benzothiopyranyl, chromonyl, chromanonyl, pyridinyl-N-oxide, isoindolinonyl, benzodioxanyl, benzoxazolinonyl, pyrrolyl N-oxide, pyrimidinyl N-oxide, pyridazinyl N-oxide, pyrazinyl N-oxide, quinolinyl N-oxide, indolyl N-oxide, indolinyl N-oxide, isoquinolyl N-oxide, quinazolinyl N-oxide, quinoxalinyl N-oxide, phthalazinyl N-oxide, imidazolyl N-oxide, isoxazolyl N-oxide, oxazolyl N-oxide, thiazolyl N-oxide, indolizinyl N-oxide, indazolyl N-oxide, benzothiazolyl N-oxide, benzimidazolyl N-oxide, pyrrolyl N-oxide, oxadiazolyl N-oxide, thiadiazolyl N-oxide, triazolyl N-oxide, tetrazolyl N-oxide, benzothiopyranyl S-oxide, benzothiopyranyl S,S-dioxide. Preferred heteroaryl groups include pyridyl, pyrimidyl, quinolinyl, indolyl, pyrrolyl, furanyl, thienyl and imidazolyl, pyrazolyl, indazolyl, thiazolyl and benzothiazolyl. In certain embodiments, each heteroaryl is selected from pyridyl, pyrimidinyl, pyridazinyl, pyrazinyl, imidazolyl, isoxazolyl, pyrazolyl, oxazolyl, thiazolyl, furanyl, thienyl, pyrrolyl, oxadiazolyl, thiadiazolyl, triazolyl, tetrazolyl, isothiazolyl, pyridinyl-N-oxide, pyrrolyl N-oxide, pyrimidinyl N-oxide, pyridazinyl N-oxide, pyrazinyl N-oxide, imidazolyl N-oxide, isoxazolyl N-oxide, oxazolyl N-oxide, thiazolyl N-oxide, pyrrolyl N-oxide, oxadiazolyl N-oxide, thiadiazolyl N-oxide, triazolyl N-oxide, and tetrazolyl N-oxide. Preferred heteroaryl groups include pyridyl, pyrimidyl, quinolinyl, indolyl, pyrrolyl, furanyl, thienyl, imidazolyl, pyrazolyl, indazolyl, thiazolyl and benzothiazolyl.

The term “heterocycloalkyl” refers to a non-aromatic ring or ring system containing at least one heteroatom that is selected from nitrogen, oxygen and sulfur, wherein said heteroatom is in a non-aromatic ring. The heterocycloalkyl may have 1, 2, 3, or 4 heteroatoms. The heterocycloalkyl may be saturated (i.e., a heterocycloalkyl) or partially unsaturated (i.e., a heterocycloalkenyl). Heterocycloalkyl includes monocyclic groups of 3 to 8 annular atoms as well as bicyclic and polycyclic ring systems, including bridged and fused systems, wherein each ring includes 3 to 8 annular atoms. The heterocycloalkyl ring is optionally fused to other heterocycloalkyl rings and/or non-aromatic hydrocarbon rings. In certain embodiments, the heterocycloalkyl groups have from 3 to 7 members in a single ring. In other embodiments, heterocycloalkyl groups have 5 or 6 members in a single ring. In some embodiments, the heterocycloalkyl groups have 3, 4, 5, 6, or 7 members in a single ring. Examples of heterocycloalkyl groups include, for example, azabicyclo[2.2.2]octyl, azabicyclo[3.2.1]octyl, 2,5-diazabicyclo[2.2.1]heptyl, morpholinyl, thiomorpholinyl, thiomorpholinyl S-oxide, thiomorpholinyl S,S-dioxide, 2-oxazolidonyl, piperazinyl, homopiperazinyl, piperazinonyl, pyrrolidinyl, azepanyl, azetidinyl, pyrrolinyl, tetrahydropyranyl, piperidinyl, tetrahydrofuranyl, tetrahydrothienyl, 3,4-dihydroisoquinolin-2(1H)-yl, isoindolindionyl, homopiperidinyl, homomorpholinyl, homothiomorpholinyl, homothiomorpholinyl S,S-dioxide, oxazolidinonyl, dihydropyrazolyl, dihydropyrrolyl, dihydropyrazinyl, dihydropyridinyl, dihydropyrimidinyl, dihydrofuryl, dihydropyranyl, imidazolidonyl, tetrahydrothienyl S-oxide, tetrahydrothienyl S,S-dioxide and homothiomorpholinyl S-oxide. Heterocycloalkyl groups include morpholinyl, 3,4-dihydroisoquinolin-2(1H)-yl, tetrahydropyranyl, piperidinyl, aza-bicyclo[2.2.2]octyl, γ-butyrolactonyl (i.e., an oxo-substituted tetrahydrofuranyl), γ-butryolactamyl (i.e., an oxo-substituted pyrrolidine), pyrrolidinyl, piperazinyl, azepanyl, azetidinyl, thiomorpholinyl, thiomorpholinyl S,S-dioxide, 2-oxazolidonyl, imidazolidonyl, isoindolindionyl, piperazinonyl.

The term “cycloalkyl” refers to a non-aromatic carbocyclic ring or ring system, which may be saturated (i.e., a cycloalkyl) or partially unsaturated (i.e., a cycloalkenyl). The cycloalkyl ring optionally may be fused to or otherwise attached (e.g., bridged systems) to other cycloalkyl rings. Certain examples of cycloalkyl groups present in the disclosed compounds have from 3 to 7 members in a single ring, such as having 5 or 6 members in a single ring. In some embodiments, the cycloalkyl groups have 3, 4, 5, 6, or 7 members in a single ring. Examples of cycloalkyl groups include, for example, cyclohexyl, cyclopentyl, cyclobutyl, cyclopropyl, tetrahydronaphthyl and bicyclo[2.2.1]heptane.

The term “siloxane” refers generally to materials including the linkage Si—O—Si. The term “siloxane” may refer to disiloxane, i.e., R₃Si—O—Si—R₃, or polysiloxane, i.e., R₃Si—O—[SiR₂—O]ₙ—SiR₃, wherein n is at least one. As used herein, the term “siloxane” includes cyclic polysiloxanes. The term “siloxane repeat unit” or “siloxane group” refers to the repeating —[SiR₂—O]— units comprising a polysiloxane.

The term “organosiloxane” refers compounds containing to the siloxane linkage, i.e., Si—O—Si, wherein one or more silicon atom is bound to carbon and/or hydrogen, e.g., R₃Si—O—Si-R₃ or R₃Si—O—[SiR₂—O]ₙ—SiR₃, wherein at least one R includes carbon and/or hydrogen. For example, hexamethyldisiloxane, poly(dimethylsiloxane), and methyl hydrosiloxane-dimethylsiloxane copolymer are organosiloxanes.

The term “silane” refers to saturated chemical compounds consisting of one or multiple silicon atoms linked to each other or one or multiple atoms of other chemical elements as the centers of multiple single bonds. The person of ordinary skill in the art will appreciate that certain siloxanes, e.g., tetrakis(dimethylsilyl) orthosilicate, may also be referred to as silanes.

The term “organosilane” refers to silanes, wherein one or more silicon atoms is bound to carbon. For example, tetrakis(dimethylsilyl) orthosilicate and tetramethyl silane are organosilanes.

The term “hydride” refers to a hydrogen functional group bonded to a more electropositive element or group. For example, calcium hydride and sodium hydride both comprise hydride functional groups. In another example, trimethylsilane and hydride-terminated poly(dimethylsiloxane) both comprise hydride functional groups.

The term “substituted,” when used to modify a specified group or radical, means that one or more hydrogen atoms of the specified group or radical are each, independently of one another, replaced with the same or different substituent groups as defined below, unless specified otherwise.

The terms “polymerizable” and “polymerized” refer to one or more compounds that can be reacted to provide a larger compound, and to one or more compounds that have been reacted to provide a larger compound, respectively. For example, a composition of a single compound may be polymerizable (i.e., a monomer), and, upon polymerization, may provide a polymerized compound comprising repeating monomer units. Polymerizable or polymerized compositions may also include “curable” or “cured” compositions, or “cross-linkable” or “cross-linked” compositions, in which compositions comprising polymers and, optionally, monomers and/or cross-linkers, can be, or have been, reacted to provide a composition of larger compounds.

The disclosure relates to curable articles having a first layer and a second layer, the first layer comprising a first cross-linkable polymer having unsaturated carbon bonds, a first cross-linker having silicon-hydride functional groups, and a hydrosilylation catalyst, the second layer comprising a second cross-linkable polymer having unsaturated carbon bonds, a second cross-linker having silicon hydride functional groups, and a hydrosilylation catalyst. The disclosure demonstrates that such articles, which can be formed at low temperatures and can be co-cured, can exhibit relatively strong interfacial adhesion.

Accordingly, one aspect of the disclosure is a curable article. The curable article includes a first layer having a first side and an opposed second side, the first layer comprising a first cross-linkable polymer comprising at least about two unsaturated carbon bonds, present in the first layer in an amount within the range of 10 wt. % to 99.9 wt. %, a first cross-linker comprising at least about two silicon hydride functional groups, present in the first layer in an amount within the range of 0.1 wt. % to 20 wt. %, and an effective amount of a first hydrosilylation catalyst. The curable article includes a second layer having a first side disposed in contact with the first side of the first layer and an opposed second side, the second layer comprising a second cross-linkable polymer comprising at least two unsaturated carbon bonds, present in the second layer in an amount within the range of 10 wt. % to 99.9 wt. %, a second cross-linker comprising at least two silicon hydride functional groups, present in the second layer in an amount within the range of 0.1 wt. % to 20 wt. %, and an effective amount of a second hydrosilylation catalyst.

As used herein, a cross-linkable polymer is a polymer that is cross-linkable by hydrosilylation through its unsaturated carbon bonds with appropriate silicon hydride-bearing cross-linkers. Moreover, when a chemical substance described herein is referenced in the singular, it is to be understood that such substance (especially when in polymeric form) will contain a distribution of individual molecules having somewhat different characteristics. Accordingly, structural attributes described herein are understood to be on average, on a per-molecule basis. Moreover, even when a chemical substance is described in the singular, it is understood that such description pertains to multiple such substances in combination. Accordingly, “a first cross-linkable polymer comprising at least about two unsaturated carbon bonds” refers not only to a material having on average at least about two unsaturated carbon bonds per molecule, but also combinations of materials each having on average at least about two unsaturated carbon bonds per molecule. In certain embodiments, “at least about two” of any moiety described herein is at least 1.90, at least 1.95, or even at least 1.98 of that moiety per molecule on average. And “about two” of a moiety means, in certain embodiments, in the range of 1.90-2.10, or 1.95-2.05 or 1.98-2.02 of that moiety per molecule on average.

In various aspects and embodiments, the carbon bonds of the first cross-linkable polymer and the second cross-linkable polymer of the curable article as otherwise described herein are cross-linkable by hydrosilylation through their unsaturated carbon bonds. There are a number of types of unsaturated carbon bonds that are cross-linkable through hydrosilylation. The most common example in the art is the carbon-carbon double bond, e.g., as in vinyl, allyl, and (meth)acryl compounds. But there are other types of unsaturated carbon bonds that can be amenable to cross-linking by hydrosilylation, such as carbon-carbon triple bonds, and a variety of carbon-heteroatom bonds. Accordingly, in certain embodiments as otherwise described herein, each unsaturated carbon bond is independently selected from carbon-carbon bonds and carbon-heteroatom bonds. In certain such embodiments, the carbon-carbon bonds include carbon-carbon double bonds and carbon-carbon triple bonds. In certain such embodiments, the carbon-heteroatom bonds include carbon-oxygen double bonds, carbon-nitrogen double bonds, and carbon-nitrogen triple bonds. In all such cases, to be considered “unsaturated carbon bonds” for purposes of this description, a bond has to be reactive with silicon hydride in the presence of the hydrosilylation catalyst in the layer.

In certain embodiments as otherwise described herein, each unsaturated carbon bond is a carbon-carbon double bond. In certain such embodiments, one or more carbon-carbon double bonds comprise a terminal alkenyl group such as, for example, a vinyl group, an allyl group, a but-3-enyl group, etc. Such groups can be found in vinyl compounds, in allyl compounds, and in (meth)acryl compounds, among others. In certain such embodiments, one or more carbon-carbon double bonds comprise a non-terminal alkenyl group such as, for example, a prop-1-enyl group, a but-2-enyl group, etc. Such groups can be found, for example, in maleimide groups.

In certain embodiments as otherwise described herein, each unsaturated carbon bond is a carbon-carbon triple bond. In certain such embodiments, one or more carbon-carbon triple bonds comprise a terminal alkynyl group such as, for example, an acetylenyl group, a prop-2-ynyl group, a but-3-ynyl group, etc. In certain such embodiments, one or more carbon-carbon triple bonds comprise a non-terminal alkynyl group such as, for example, a prop-1-ynyl group, a but-2-ynyl group, etc. In certain embodiments, cross-linking the one or more carbon-carbon triple bonds is catalyzed by a hydrosilylation catalyst comprising a transition metal such as, for example, platinum, rhodium, cobalt, etc.

In certain embodiments as otherwise described herein, each unsaturated bond is an unsaturated carbon-heteroatom bond selected from carbon-oxygen double bonds, carbon-nitrogen double bonds, and carbon-nitrogen triple bonds. For example, the carbon-oxygen double bond can be a carbonyl of an aldehyde, a ketone, or an ester. The carbon-nitrogen double bond can be an imine, e.g., a primary aldimine or a primary ketimine. The carbon-nitrogen triple bond can be a nitrile. In certain embodiments, cross-linking the one or more carbon-heteroatom bonds is catalyzed by a hydrosilylation catalyst comprising borane, for example, B(C₆F₅)₃. In other embodiments, cross-linking the one or more carbon-heteroatom bonds is catalyzed by a hydrosilylation catalyst comprising a transition metal such as, for example, platinum, palladium, rhodium, copper, iron, zinc, etc.

In certain embodiments as otherwise described herein, the first cross-linkable polymer comprises about two unsaturated carbon bonds (i.e., per molecule, on average). For example, in certain such embodiments, the first cross-linkable polymer comprises an unsaturated carbon bond (e.g., a carbon-carbon double bond or a carbon-carbon triple bond) at each of a first end and a second end of the polymer. However, in other embodiments as otherwise described herein, the first cross-linkable polymer comprises more than about two unsaturated carbon bonds (i.e., per molecule, on average), for example at least three, at least four, or at least five unsaturated carbon bonds. Such materials can be branched with more than two ends, each end bearing an unsaturated carbon bond. As another examples, such materials can be based on copolymers having unsaturated carbon bonds pendant on a fraction of the monomers thereof.

The person of ordinary skill in the art will appreciate that a wide variety of first cross-linkable polymers can be used in the curable articles as otherwise described herein. For example, in certain embodiments, the first cross-linkable polymer is a polysiloxane. A wide variety of polysiloxanes cross-linkable through hydrosilylation are known. The cross-linkable unsaturated carbon bonds can be provided at the ends of the polysiloxane, provided as pendant groups from internal siloxanes, or a combination of at one or more ends of the polysiloxane and as pendant groups from one or more internal polysiloxanes. In certain embodiments, the first cross-linkable polymer includes an unsaturated carbon bond-terminated polysiloxane, e.g., selected from vinyl-terminated polysiloxanes (e.g., vinyl-terminated polydimethylsiloxanes; vinyl-terminated diphenylsiloxane-dimethylsiloxane copolymers; vinyl-terminated trifluoropropylmethylsiloxane-dimethylsiloxane copolymers; vinyl-terminated diethylsiloxane-dimethylsiloxane copolymers; and vinyl T-structure polymers); and (meth)acryl-terminated polysiloxanes (e.g., methacryloxypropyl-terminated polydimethylsiloxane; (3-acryloxy-2-hydroxypropoxypropyl)-terminated polydimethylsiloxanes; and (meth)acryloxypropyl-terminated branched polydimethylsiloxanes). In certain embodiments, the first cross-linkable polymer includes a polysiloxane having unsaturated carbon bonds pendant from internal siloxanes, e.g., selected from vinyl-pendant polysiloxanes (e.g., vinylmethylsiloxane-dimethylsiloxane copolymers; trimethylsiloxy-terminated vinylmethylsiloxane-dimethylsiloxane copolymers; silanol terminated 4-6% OH, vinylmethylsiloxane homopolymers; (3-5% vinylmethylsiloxane)-(35-40% octylmethylsiloxane)-(dimethylsiloxane) terpolymers; (3-5% vinylmethylsiloxane)-(35-40% phenylmethylsiloxane)-(dimethylsiloxane) terpolymers) and (meth)acryl-pendant polysiloxanes (e.g., (methacryloxypropyl)methylsiloxane-dimethylsiloxane copolymers; (acryloxypropyl)methylsiloxane-dimethylsiloxane copolymers. And in certain embodiments, the first cross-linkable polymer includes an unsaturated carbon bond-terminated polysiloxane having unsaturated carbon bonds pendant from internal siloxanes, such as vinyl-terminated polysiloxane having vinyl groups pendant from internal siloxanes (e.g., vinyl-terminated vinylmethylsiloxane-dimethylsiloxane copolymers).

For example, in certain embodiments, the first cross-linkable polymer comprises a compound having the formula R^{1A}R^{1B}R^{1C}Si—(OSiR^{1D}R^{1E})ₓ-SiR^{1F}R^{1G}R^{1H}, wherein each instance of R^{1A}, R^{1B}, R^{1C}, R^{1D}, R^{1E}, R^{1F}, R^{1G} and R^{1H} is independently hydrogen or C₁-C₃₀ hydrocarbon, in which x is in the range of 0-10,000, provided that two or more instances of R^{1A}, R^{1D} and R^{1F} include a cross-linkable unsaturated carbon bond as described above. For example, in certain embodiments, R^{1A} and R^{1F} include a cross-linkable unsaturated carbon bond (e.g., a vinyl). In other embodiments, two or more instances of R¹′ within the molecule (i.e., on two different instances of OSiR^{1D}R^{1E}) include a cross-linkable unsaturated carbon bond (e.g., a vinyl). In certain such embodiments, x is in the range of 0-5,000, or 0-1,000, or 0-500, or 0-100, or 5-10,000, or 5-5,000, or 5-1,000, or 5-500, or 5-100, or 10-10,000, or 10-5,000, or 10-1,000, or 10-500, or 10-100, or 50-10,000, or 50-5,000, or 50-1,000, or 50-500, or 100-10,000, or 100-5,000, or 100-1,000, or 500-10,000, or 500-5,000. Branched siloxanes of the structure [R^{1A}R^{1B}R^{1C}Si—(OSiR^{1D}R^{1E})_{y}—O—]₃—SiR^{1I}, in which y is 0-3,500, each instance of R^{1A}, R^{1B}, R^{1C}, R^{1D}, R^{1E}, R^{1I} isindependently hydrogen or C₁-C₃₀ hydrocarbon, provided that two or more instances of R^{1A}, R^{1D} and R^{1I} include a cross-linkable unsaturated carbon bond as described above, are also suitable for use. In certain embodiments of such siloxanes each instance of R^{1A}, R^{1B}, R^{1C}, R^{1D}, R^{1E}, R^{1F}, R^{1G}, R^{1H} and R^{1I} is independently hydrogen or C₁-C₂₀ hydrocarbon, for example, C₁-C₁₀ hydrocarbon.

For example, in certain embodiments, the first cross-linkable polymer comprises a compound having the formula R^{1A}R^{1B}R^{1C}Si—(OSiR^{1D}R^{1E})ₓ—O—SiR^{1F}R^{1G}R^{1H}, wherein each instance of R^{1A}, R^{1B}, R^{1C}, R^{D}, R^{1E}, R^{1F}, R^{1G}, and R^{1H} is independently hydrogen or C₁-C₃₀ hydrocarbon, and wherein two or more instances of R^{1A}, R^{1D} and R^{1F} include a cross-linkable unsaturated carbon bond, the first cross-linkable polymer has a number average molecular weight within the range of about 300 Da to about 10,000 Da, or within the range of about 10,000 Da to about 1,000,000 Da. For example, in certain such embodiments, the first cross-linkable polymer has a molecular weight within the range of about 300 Da to about 9,000 Da, or about 300 Da to about 8,000 Da, or about 300 Da to about 7,000 Da, or about 300 Da to about 6,000 Da, or about 300 Da to about 5,000 Da, or about 300 Da to about 4,000 Da, or about 300 Da to about 3,000 Da, or about 300 Da to about 2,000 Da, or about 300 Da to about 1,000 Da, or about 500 Da to about 10,000 Da, or about 1,000 Da to about 10,000 Da, or about 2,000 Da to about 10,000 Da, or about 3,000 Da to about 10,000 Da, or about 4,000 Da to about 10,000 Da, or about 5,000 Da to about 10,000 Da, or about 6,000 Da to about 10,000 Da, or about 7,000 Da to about 10,000 Da, or about 500 Da to about 2,500 Da, or about 1,500 Da to about 3,500 Da, or about 2,500 Da to about 4,500 Da, or about 3,500 Da to about 5,500 Da, or about 4,500 Da to about 6,500 Da, or about 5,500 Da to about 7,500 Da, or about 6,500 Da to about 8,500 Da, or about 7,500 Da to about 9,500 Da. In another example, in certain such embodiments, the first cross-linkable polymer has a molecular weight within the range of about 10,000 Da to about 900,000 Da, or about 10,000 Da to about 800,000 Da, or about 10,000 Da to about 700,000 Da, or about 10,000 Da to about 600,000 Da, or about 10,000 Da to about 500,000 Da, or about 10,000 Da to about 400,000 Da, or about 10,000 Da to about 300,000 Da, or about 10,000 Da to about 200,000 Da, or about 10,000 Da to about 100,000 Da, or about 100,000 Da to about 1,000,000 Da, or about 200,000 Da to about 1,000,000 Da, or about 300,000 Da to about 1,000,000 Da, or about 400,000 Da to about 1,000,000 Da, or about 500,000 Da to about 1,000,000 Da, or about 600,000 Da to about 1,000,000 Da, or about 700,000 Da to about 1,000,000 Da, or about 800,000 Da to about 1,000,000 Da, or about 900,000 Da to about 1,000,000 Da, or about 100,000 Da to about 300,000 Da, or about 200,000 Da to about 400,000 Da, or about 300,000 Da to about 500,000 Da, or about 400,000 Da to about 600,000 Da, or about 500,000 Da to about 700,000 Da, or about 600,000 Da to about 800,000 Da, or about 700,000 Da to about 900,000 Da. In certain such embodiments, R_{1A} and R_{1F} include a cross-linkable unsaturated carbon bond (e.g., a vinyl). In other such embodiments, two or more instances of R^{1D} within the molecule (i.e., on two different instances of OSiR_{1D}R^{1E}) include a cross-linkable unsaturated carbon bond (e.g., a vinyl).

Accordingly, a variety of polysiloxanes are suitable for use as the first cross-linkable polymer. In certain embodiments, at least 70 wt. %, at least 90 wt. %, or even at least 95 wt. % of the first cross-linkable polymer is made up of one or more polysiloxanes. For example, in certain embodiments, substantially all the first cross-linkable polymer is made up of one or more polysiloxanes.

Another suitable material for use as the first cross-linkable polymer is a cross-linkable fluorinated polyether compound having a fluorinated polyether block having at least two ends, and at least about two unsaturated carbon bonds (e.g., disposed at ends of the fluorinated polyether block). The fluorinated polyether block in certain desirable embodiments is a perfluorinated polyether block. The fluorinated polyether block can be, for example, have the structure —Yₙ—, where each Y is —CF₂CF₂O—, —CF₂CF₂CF₂O—, —CF₂CF₂CF₂CF₂O—, —CF(CF₃)CF₂O—, or —C(CF₃)₂O—. For example, in certain such embodiments, each Y is —CF(CF₃)CF₂O—. n can be, for example, in the range of 5-500, for example, 5-300, or 5-200, or 5-100, or 10-500, or 10-300, or 10-200, or 10-100, or 50-500, or 50-300, or 50-200. In other such embodiments, n can be, for example, in the range of 250-3,000, for example, 250-2,000, or 250-1,000, or 500-3,000, or 500-2,000, or 1,000-3,000, or 1,000-2,000.

In certain embodiments as otherwise described herein, the first cross-linkable polymer comprises a compound of the formula R^{2a}-X-Z-X′-R^{2b}, in which:
R^{2a} and R^{2b} are each independently C₁-C₂₀ hydrocarbon;
X is —CH₂—, —CH₂O—, —CH₂OCH₂—, —CH₂—NR⁵—C(O)—, or

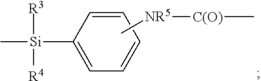

in which
   each of R³ and R⁴ is independently C₁-C₂₀ hydrocarbon; and
   R⁵ is hydrogen or C₁-C₂₀ hydrocarbon;
X′ is —CH₂—, —OCH₂—, —CH₂OCH₂—, —C(O)—NR⁵—CH₂—, or

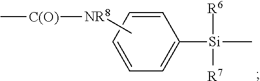

in which
   each of R⁶ and R⁷ is independently C₁-C₂₀ hydrocarbon; and
   R⁸ is hydrogen or C₁-C₂₀ hydrocarbon; and
Z is a fluorinated polyether block (e.g., as described above),
   wherein at least two of R^{2a}, R^{2b}, R³, R⁴, R⁵ R⁶, R⁷, and R⁸ include an unsaturated carbon bond.

In certain such embodiments, each of R^{2a} and R^{2b} includes an unsaturated carbon bond. For example, in certain embodiments, each of R^{2a} and R^{2b} is a vinyl group.

Certain suitable cross-linkable fluorinated polyethers are available under the trade name SIFEL from Shin-Etsu. Cross-linkable fluorinated polyethers are further described in Japanese Patent Application Publications Hesei 8-199070 and 2001-1069893, U.S. Pat. No. 6,297,339 and U.S. Patent Application Publication no. 2004/0006160.

The first cross-linkable polymer can be present in the first layer in a variety of amounts. The person of ordinary skill in the art can select an amount of first cross-linkable polymer that provides an ultimate cured material with desirable properties. The person of ordinary skill in the art can also account for the presence of any fillers and non-cross-linkable polymeric material in the layer. For example, in certain embodiments as otherwise described herein, the first cross-linkable polymer is present in the first layer in an amount within the range of 20 wt. % to 99.9 wt. %, or 40 wt. % to 99.99 wt. %, or 65 wt. % to 99.9 wt. %, or 70 wt. % to 99.9 wt. %, or 80 wt. % to 99.9 wt. %, or 90 wt. % to 99.9 wt. %, or 95 wt. % to 99.9 wt. %. In other embodiments as otherwise described herein, the first cross-linkable polymer is present in the first layer in an amount within the range of 10 wt. % to 98 wt. %, e.g., 20 wt. % to 98 wt. %, or 40 to 98 wt. %, or 65 wt. % to 98 wt. %, or 70 wt. % to 98 wt. %, or 80 wt. % to 98 wt. %, or 90 wt. % to 98 wt. %. In other embodiments as otherwise described herein, the first cross-linkable polymer is present in the first layer in an amount within the range of 10 wt. % to 90 wt. %, e.g., 20 wt. % to 90 wt. %, or 40 to 90 wt. %, or 65 wt. % to 90 wt. %, or 70 wt. % to 90 wt. %. In other embodiments as otherwise described herein, the first cross-linkable polymer is present in the first layer in an amount in the range of 10 wt. % to 80 wt. %, or 20 wt. % to 80 wt. %, or 40 wt. % to 80 wt. %, or 10 wt. % to 60 wt. %, or 20 wt. % to 60 wt. %.

As described above, the curable article includes a second layer having a first side disposed in contact with the first side of the first layer and an opposed second side. The second layer includes a second cross-linkable polymer comprising at least about two unsaturated carbon bonds, present in the second layer in an amount within the range of 10 wt. % to 99.9 wt. %.

The person of ordinary skill in the art will appreciate that a wide variety of second cross-linkable polymers can be used in the curable articles as otherwise described herein. Advantageously, the methods described herein can be used to provide good adhesion between a polysiloxane- or fluorinated polyether-based material of the first layer with a different material of a second layer, without the need for a tie layer between them. Notably, the second layer does not include a substantial amount (for example, no more than 5%, or no more than 3%, or no more than 2%, e.g., no more than 1% or even no more than 0.5%) of the first cross-linkable polymer. That is, in various embodiments of the disclosure, there is no need to blend the first cross-linkable polymer into the second layer in order to provide adhesion between the layers.

In certain embodiments as otherwise described herein, the second cross-linkable polymer is a thermosetting material having at least about two unsaturated carbon bonds (i.e., on average per molecule). In certain embodiments as otherwise described herein, the second cross-linkable polymer is an elastomer having at least about two unsaturated carbon bonds. For example, in certain embodiments as otherwise described herein, the second cross-linkable polymer is an ethylene propylene diene rubber, a polybutadiene rubber, a butyl rubber, a nitrile rubber, or a polyisoprene rubber. In certain embodiments as otherwise described herein, the second cross-linkable polymer is selected from any elastomer having terminal-alkenyl functionality (i.e., comprising a first terminal group and a second terminal group, each group comprising a C₁-C₁₂ hydrocarbon comprising an alkenyl group or an alkynyl group). For example, in certain such embodiments, the second cross-linkable polymer is an elastomer having terminal-vinyl functionality. Of course, in other embodiments rubbers with non-terminal functionality can be used.

In certain embodiments as otherwise described herein, the second cross-linkable polymer has a number average molecular weight within the range of about 4,000 Da to about 10,000,000 Da. For example, in certain such embodiments, the first cross-linkable polymer has a molecular weight within the range of about 10,000 Da to about 10,000,000 Da, or about 100,000 Da to about 10,000,000 Da, or about 250,000 Da to about 10,000,000 Da, or about 500,000 Da to about 10,000,000 Da, or about 750,000 Da to about 10,000,000 Da, or about 1,000,000 Da to about 10,000,000 Da, or about 2,500,000 Da to about 10,000,000 Da, or about 5,000,000 Da to about 10,000,000 Da, or about 7,500,000 Da to about 10,000,000 Da, or about 4,000 Da to about 7,500,000 Da, or about 4,000 Da to about 5,000,000 Da, or about 4,000 Da to about 2,500,000 Da, or about 4,000 Da to about 1,000,000 Da, or about 4,000 Da to about 750,000 Da, or about 4,000 Da to about 500,000 Da, or about 4,000 Da to about 250,000 Da, or about 4,000 Da to about 100,000 Da, or about 4,000 Da to about 50,000 Da, or about 4,000 Da to about 10,000 Da, or about 10,000 Da to about 2,000,000 Da, or about 1,000,000 Da to about 3,000,000 Da, or about 2,000,000 Da to about 4,000,000 Da, or about 3,000,000 Da to about 5,000,000 Da, or about 4,000,000 Da to about 6,000,000 Da, or about 5,000,000 Da to about 7,000,000 Da, or about 6,000,000 Da to about 8,000,000 Da, or about 7,000,000 Da to about 9,000,000 Da.

In various aspects and embodiments, the viscosity of the second cross-linkable polymer is suitable for processing (e.g., for extruding) at a temperature within the range of about 5° C. to about 80° C. For example, in certain embodiments as otherwise described herein, the second cross-linkable polymer has a viscosity within the range of about 1,000 cP to about 1,000,000,000 cP, or about 100,000 cP to about 100,000,000 cP at a temperature within the range of about 5° C. to about 80° C.

In certain embodiments as otherwise described herein, the second cross-linkable polymer is an ethylene propylene diene rubber, e.g., an ethylene propylene diene rubber having a vinyl norbornene group pendant from the monomers thereof. In certain embodiments as otherwise described herein, the second cross-linkable polymer is a butadiene rubber, e.g., a butadiene rubber having a vinyl group pendant from the monomers thereof. In certain embodiments as otherwise described herein, the second cross-linkable polymer is a styrene-butadiene rubber, e.g., a styrene-butadiene rubber having a vinyl group pendant from the monomers thereof. In certain embodiments as otherwise described herein, the second cross-linkable polymer is an isoprene rubber having a vinyl group or a methacrylate group pendant from the monomers thereof.

In certain embodiments as otherwise described herein, the second cross-linkable polymer comprises a compound of the formula R₂ₐ-X-Z-X′-R^{2b}, as described above. In such embodiments, the first cross-linkable polymer does not include substantial amounts (e.g., in excess of 5 wt. %, in excess of 3 wt. %, in excess of 2 wt. %, in excess of 1 wt. %, or even in excess of 0.5 wt. %) of a compound of the formula R^{2a}-X-Z-X′-R^{2b}. In such embodiments, the articles and methods described herein can provide for good interfacial adhesion between a polysiloxane-based material of the first layer and a fluorinated polyether-based material of the second layer.

In certain embodiments, the second cross-linkable polymer does not include substantial amounts (e.g., in excess of 5 wt. %, in excess of 3 wt. %, in excess of 2 wt. %, in excess of 1 wt. %, or even in excess of 0.5 wt. %) of a polysiloxane. Thus, the articles and methods described herein can provide for good interfacial adhesion between a polysiloxane-based material of the first layer and a non-polysiloxane-based material of the second layer.

In certain embodiments, the first cross-linkable polymer includes a compound of the formula R^{2a}-X-Z-X′-R^{2b}, and the second cross-linkable polymer does not include substantial amounts (e.g., in excess of 5 wt. %, in excess of 3 wt. %, in excess of 2 wt. %, in excess of 1 wt. %, or even in excess of 0.5 wt. %) of a polysiloxane or of a compound having the formula R^{2a}-X-Z-X′-R^{2b}. In certain such embodiments, the second cross-linkable polymer is a rubber (e.g., an ethylene propylene diene rubber, a polybutadiene rubber, a butyl rubber, or a polyisoprene rubber). Thus, the articles and methods described herein can provide for good interfacial adhesion between the SIFEL-type materials and conventional curable elastomers.

It is desirable that the unsaturated carbon bonds of the first cross-linkable polymer are similar to those of the second cross-linkable polymer, such that they can both be reactive with silicon hydrides under the influence of either of the first cross-linker and the second cross-linker under the same set of curing conditions. Accordingly, in certain embodiments, the unsaturated carbon bonds of the first cross-linkable polymer and the unsaturated carbon bonds of the first cross-linkable polymer are both carbon-carbon double bonds. In certain embodiments, the unsaturated carbon bonds of the first cross-linkable polymer and the unsaturated carbon bonds of the first cross-linkable polymer are both carbon-carbon triple bonds.

The second cross-linkable polymer can be present in the second layer in a variety of amounts. The person of ordinary skill in the art can select an amount of second cross-linkable polymer that provides an ultimate cured material with desirable properties. The person of ordinary skill in the art can also account for the presence of any fillers and non-cross-linkable polymeric material in the layer. For example, in certain embodiments as otherwise described herein, the second cross-linkable polymer is present in the second layer in an amount within the range of 20 wt. % to 99.9 wt. %, or 40 wt. % to 99.99 wt. %, or 65 wt. % to 99.9 wt. %, or 70 wt. % to 99.9 wt. %, or 80 wt. % to 99.9 wt. %, or 90 wt. % to 99.9 wt. %, or 95 wt. % to 99.9 wt. %. In other embodiments as otherwise described herein, the second cross-linkable polymer is present in the second layer in an amount within the range of 10 wt. % to 98 wt. %, e.g., 20 wt. % to 98 wt. %, or 40 to 98 wt. %, or 65 wt. % to 98 wt. %, or 70 wt. % to 98 wt. %, or 80 wt. % to 98 wt. %, or 90 wt. % to 98 wt. %. In other embodiments as otherwise described herein, the second cross-linkable polymer is present in the second layer in an amount within the range of 10 wt. % to 90 wt. %, e.g., 20 wt. % to 90 wt. %, or 40 to 90 wt. %, or 65 wt. % to 90 wt. %, or 70 wt. % to 90 wt. %. In other embodiments as otherwise described herein, the second cross-linkable polymer is present in the second layer in an amount in the range of 10 wt. % to 80 wt. %, or 20 wt. % to 80 wt. %, or 40 wt. % to 80 wt. %, or 10 wt. % to 60 wt. %, or 20 wt. % to 60 wt. %.

As noted above, the first layer includes a first cross-linker including at least about two silicon-hydride functional groups (i.e., on average per molecule) and at a second cross-linker including at least about two silicon-hydride functional groups. Without intending to be bound by theory, the present inventors believe that enhanced interfacial adhesion results from cross-linker of the first layer reacting with cross-linkable groups of the second layer, and/or cross-linker of the second layer reacting with cross-linkable groups of the first layer, thus making covalent cross-linker bridges between the first and second cross-linkable polymers.

These cross-linkers can be the sole or major cross-linker of each of the layers. For example, polysiloxanes and the SIFEL-type materials described above be cross-linked by hydride-containing materials like siloxanes and silanes. However, especially where the material of a layer is something other than a polysiloxane or a SIFEL-type material, the silicon-hydride need not provide the sole or even the major cross-linking activity. Vulcanizable or otherwise cross-linkable rubbers, elastomers, and other polymers can in many embodiments have much of their cross-linking done another way, with the cross-linker of that layer providing only a minor degree of cross-linking within the layer.

The first cross-linker can be the same as the second cross-linker, or can be different than the second cross-linker.

In certain embodiments as otherwise described herein, the first cross-linker comprises about two silicon-hydride functional groups. In certain embodiments as otherwise described herein, the second cross-linker comprises about two silicon-hydride functional groups. In certain such embodiments, each of the first cross-linker and the second cross-linker comprise about two silicon-hydride functional groups. Cross-linkers with about two silicon-hydride functional groups can be formed, for example, as linear polysiloxanes in which each end group includes an Si—H group. In certain embodiments as otherwise described herein, one or each of the first cross-linker and the second cross-linker comprises more than about two silicon-hydride functional groups, e.g., three or more, four or more, or even five or more silicon-hydride groups. For example, such materials can be provided as polysiloxanes having internal siloxanes substituted with hydrogen. And, of course, polysiloxanes with both terminal and internal hydrides can be used.

In certain embodiments as otherwise described herein, one or more of the first cross-linker and the second cross-linker is a polysiloxane (e.g., a disiloxane or a polysiloxane of a higher degree of polymerization).

Examples of suitable cross-linkers include, for example, dimethylsilyloxy-terminated polydimethylsiloxanes, dimethylsilyloxy-terminated polyphenylmethylsiloxane; trimethylsiloxy-terminated methylhydrosiloxane-dimethylsiloxane copolymers; dimethylsilyloxy-terminated methylhydrosiloxane-dimethylsiloxane copolymers; trimethylsiloxy-terminated polymethylhydrosiloxanes; triethylsiloxy-terminated polyethylhydrosiloxane; dimethylsilyloxy-terminated polyphenyl-(dimethylhydrosiloxy)siloxane; dimethylsilyloxy-terminated methylhydrosiloxane-phenylmethylsiloxane copolymers; and methyl hydrosiloxane-octylmethylsiloxane copolymers and terpolymers.

In certain embodiments as otherwise described herein, the viscosity of one or each of the first cross-linker and the second cross-linker is up to about 500 cP. In certain embodiments as otherwise described herein, the viscosity of one or each of the first cross-linker and the second cross-linker is within the range of about 10 cP to about 10,000 cP. For example, in certain such embodiments, the viscosity of one or each of the first cross-linker and the second cross-linker is within the range of about 10 cP to about 7,500 cP, or about 10 cP to about 5,000 cP, or about 10 cP to about 2,500 cP, or about 10 cP to about 1,000 cP, or about 10 cP to about 750 cP, or about 10 cP to about 500 cP.

In certain embodiments as otherwise described herein, one or each of the first cross-linker and the second cross-linker comprises a compound of the formula:

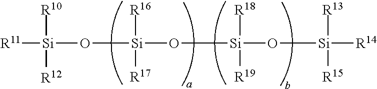

wherein:
each of R¹⁰, R¹¹, R¹², R¹³, R¹⁴, R¹⁵, R¹⁶, R¹⁷, R¹⁸, and R¹⁹ is independently hydrogen, C₁-C₆₀ hydrocarbon, or

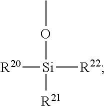

in which each of R²¹, R²², and R²³ is independently hydrogen or C₁-C₆₀ hydrocarbon; and
each of a and b is 0-1,000.

In certain embodiments as otherwise described herein, one or each of the first cross-linker and the second cross-linker comprises a compound of Formula III in which b is 0. In certain such embodiments, R¹¹ and R¹⁴ are hydrogen. In certain such embodiments, each of R¹⁰, R¹², R¹³, and R¹⁵ is independently C₁-C₆₀ hydrocarbon. For example, in certain embodiments as otherwise described herein, each of R¹⁰, R¹², R¹³, and R¹⁵ is independently C₁-C₁₂ hydrocarbon, e.g., selected from C₁-C₁₂ alkyl, C₄-C₁₂ cycloalkyl, and C₆-C₁₂ aryl. In certain such embodiments, each of R¹⁶ and R¹⁷ is independently C₁-C₆₀ hydrocarbon. In certain embodiments as otherwise described herein, each of R¹⁶ and R¹⁷ is independently C₁-C₁₂ hydrocarbon, e.g., selected from C₁-C₁₂ alkyl, C₄-C₁₂ cycloalkyl, and C₆-C₁₂ aryl. In certain embodiments as otherwise described herein, R¹⁶ is C₁-C₆₀ hydrocarbon and R¹⁷ is

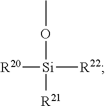

in which each of R²⁰ and R²² is independently C₁-C₆₀ hydrocarbon, and R²¹ is hydrogen. In certain such embodiments, each of R²⁰ and R²² is independently C₁-C₁₂ hydrocarbon, e.g., selected from C₁-C₁₂ alkyl, C₄-C₁₂ cycloalkyl, and C₆-C₁₂ aryl.

In certain embodiments as otherwise described herein, one or each of the first cross-linker and the second cross-linker comprises a compound of Formula III in which each of a and b is independently 1-1,000. In certain such embodiments, each of a and b is independently 1-750, or 1-500, or 1-250, or 1-100, or 10-900, or 25-800, or 50-750. In certain embodiments as otherwise described herein, R¹⁸ is hydrogen and each of R¹⁰, R¹¹, R¹², R¹³, R¹⁴, R¹⁵, R¹⁶, R¹⁷, and R¹⁹ is independently C₁-C₆₀ hydrocarbon. In certain such embodiments, each of R¹⁰, R¹¹, R¹², R¹³, R¹⁴, R¹⁵, R¹⁶, R¹⁷, and R¹⁹ is independently C₁-C₁₂ hydrocarbon, e.g., selected from C₁-C₁₂ alkyl, C₄-C₁₂ cycloalkyl, and C₆-C₁₂ aryl.

In certain embodiments as otherwise described herein, the first cross-linker is present in the first layer in an amount within the range of 0.1 wt. % to 17.5 wt. %. For example, in certain embodiments as otherwise described herein, the first cross-linker is present in the first layer in an amount within the range of 0.1 wt. % to 15 wt. %, or 0.1 wt. % to 12.5 wt. %, or 0.1 wt. % to 10 wt. %, or 0.1 wt. % to 7.5 wt. %, or 0.1 wt. % to 5 wt. %, or 0.1 wt. % to 4 wt. %, or 0.1 wt. % to 3 wt. %, or 0.1 wt. % to 2 wt. %, or 0.1 wt. % to 1 wt. %, or 0.5 wt. % to 15 wt. %, or 1 wt. % to 10 wt. %, or 1 wt. % to 7.5 wt. %, or 1 wt. % to 5 wt. %.

In certain embodiments as otherwise described herein, the second cross-linker is present in the second layer in an amount within the range of 0.1 wt. % to 17.5 wt. %. For example, in certain embodiments as otherwise described herein, the second cross-linker is present in the second layer in an amount within the range of 0.1 wt. % to 15 wt. %, or 0.1 wt. % to 12.5 wt. %, or 0.1 wt. % to 10 wt. %, or 0.1 wt. % to 7.5 wt. %, or 0.1 wt. % to 5 wt. %, or 0.1 wt. % to 4 wt. %, or 0.1 wt. % to 3 wt. %, or 0.1 wt. % to 2 wt. %, or 0.1 wt. % to 1 wt. %, or 0.5 wt. % to 15 wt. %, or 1 wt. % to 10 wt. %, or 1 wt. % to 7.5 wt. %, or 1 wt. % to 5 wt. %.

In certain embodiments as otherwise described herein, the first cross-linkable polymer and the first cross-linker are present in the first layer in a relative amount such that the ratio of silicon-hydride functional groups of the first cross-linker to unsaturated carbon bonds of the first cross-linkable polymer is within the range of about 10:1 to about 0.5:1 (e.g., within the range of about 10:1 to about 1:1, or about 10:1 to about 2:1, or about 8:1 to about 2:1, or about 6:1 to about 2:1).

In certain embodiments as otherwise described herein, the second cross-linkable polymer and the second cross-linker are present in the second layer in a relative amount such that the ratio of silicon-hydride functional groups of the second cross-linker to unsaturated carbon bonds of the second cross-linkable polymer is within the range of about 10:1 to about 0.5:1 (e.g., within the range of about 10:1 to about 1:1, or about 10:1 to about 2:1, or about 8:1 to about 2:1, or about 6:1 to about 2:1).

For example, in certain embodiments as otherwise described herein, the first cross-linkable polymer is a polysiloxane, present in the first layer in an amount within the range of about 50 wt. % to 99.9 wt. %, and the second cross-linkable polymer is an elastomer, present in the second layer in an amount within the range of about 10 wt. % to 99.9 wt. %. In certain such embodiments, the first cross-linkable polymer is a vinyl-functionalized polysiloxane. In certain such embodiments, the first cross-linkable polymer is present in the first layer in an amount within the range of about 60 wt. % to 99.9 wt. %, or 70 wt. % to 99.9 wt. %, or 80 wt. % to 99.9 wt. %, or 90 wt. % to 99.9 wt. %. in certain such embodiments, the second cross-linkable polymer is an ethylene propylene diene rubber, a polybutadiene rubber, a butyl rubber, a polyisoprene rubber, or a nitrile rubber. In certain such embodiments, the second cross-linkable polymer is present in the second layer in an amount within the range of about 20 wt. % to 99.9 wt. %, or 30 wt. % to 99.9 wt. %, or 40 wt. % to 99.9 wt. %, or 50 wt. % to 99.9 wt. %, or 60 wt. % to 99.9 wt. %, or 70 wt. % to 99.9 wt. %.

In another example, in certain embodiments as otherwise described herein, the first cross-linker is present in the first layer in an amount within the range of about 0.1 wt. % to 10 wt. %, and the second cross-linker is present in the second layer in an amount within the range of about 0.1 wt. % to 10 wt. %. In certain such embodiments, the first cross-linker is present in the first layer in an amount within the range of about 0.1 wt. % to 7.5 wt. %, or 0.1 wt. % to 5 wt. %, or 0.1 wt. % to 4 wt. %, or 0.1 wt. % to 3 wt. %. In certain such embodiments, the second cross-linker is present in the second layer in an amount within the range of about 0.1 wt. % to 7.5 wt. %, or 0.1 wt. % to 5 wt. %, or 0.1 wt. % to 4 wt. %, or 0.1 wt. % to 3 wt. %. In certain such embodiments, the first cross-linker and the second cross-linker each independently comprise a compound of Formula III, in which each of R¹⁰, R¹¹, R¹², R¹³, R¹⁴, R¹⁵, R¹⁶, R¹⁷, R¹⁸, and R¹⁹ is independently hydrogen or C₁-C₁₂ hydrocarbon (e.g., selected from C₁-C₁₂ alkyl, C₄-C₁₂ cycloalkyl, and C₆-C₁₂ aryl). In certain such embodiments, each of a and b is independently 0-750, or 0-500, or 0-250, or 0-100.

As noted above, each of the first and second layers of the curable article as otherwise described herein include an effective amount of a hydrosilylation catalyst, which can be the same or different in each layer. However, it is desirable that they are the same, and/or are each effective to catalyze reaction of the cross-linker of the other layer with the cross-linkable groups of the polymer of its own layer. In various aspects and embodiments, the first hydrosilylation catalyst is capable of catalyzing a hydrosilylation reaction between an unsaturated carbon bond of the first cross-linkable polymer and a silicon-hydride functional group of the first cross-linker, and the second hydrosilylation catalyst is capable of catalyzing a hydrosilylation reaction between an unsaturated carbon bond of the second cross-linkable polymer and a silicon-hydride functional group of the second cross-linker. For example, in certain embodiments as otherwise described herein, one or each of the first hydrosilylation catalyst and the second hydrosilylation catalyst comprise titanium, iron, manganese, cobalt, copper, zinc, molybdenum, ruthenium, rhodium, palladium, tin, ytterbium, rhenium, iridium, or platinum. In certain such embodiments, the hydrosilylation catalyst is capable of catalyzing a hydrosilylation reaction between a silicon-hydride functional group and an unsaturated carbon bond selected from carbon-carbon bonds (e.g., carbon-carbon double bonds and carbon-carbon triple bonds) and carbon-heteroatom bonds (e.g., carbon-oxygen double bonds, carbon-nitrogen double bonds, and carbon-nitrogen triple bonds). In certain embodiments as otherwise described herein, one or each of the first hydrosilylation catalyst and the second hydrosilylation catalyst comprise cobalt, copper, zinc, ruthenium, or rhodium. In other embodiments as otherwise described herein, one or each of the first hydrosilylation catalyst and the second hydrosilylation catalyst comprise platinum or palladium.

In certain embodiments as otherwise described herein, the first hydrosilylation catalyst is present in the first layer in an amount within the range of about 0.001 wt. % to 10 wt. %. For example, in certain such embodiments, the first hydrosilylation catalyst is present in the first layer in an amount within the range of about 0.001 wt. % to 8 wt. %, or 0.001 wt. % to 6 wt. %, or 0.001 wt. % to 4 wt. %, or 0.001 wt. % to 3 wt. %, or 0.001 wt. % to 2 wt. %, or 0.001 wt. % to 1 wt. %. In certain embodiments as otherwise described herein, the second hydrosilylation catalyst is present in the second layer in an amount within the range of about 0.001 wt. % to 10 wt. %. For example, in certain such embodiments, the first hydrosilylation catalyst is present in the first layer in an amount within the range of about 0.001 wt. % to 8 wt. %, or 0.001 wt. % to 6 wt. %, or 0.001 wt. % to 4 wt. %, or 0.001 wt. % to 3 wt. %, or 0.001 wt. % to 2 wt. %, or 0.001 wt. % to 1 wt. %.

In certain embodiments as otherwise described herein, one or each of the first layer and the second layer further comprises one or more inhibitors. For example, in certain embodiments as otherwise described herein, an article layer comprising a heat-activated hydrosilylation catalyst further comprises an inhibitor. In various aspects and embodiments, the inhibitor is selected from those known in the art. For example, in certain embodiments, an article layer comprising a heat-activated hydrosilylation catalyst further comprises an inhibitor selected from esters, alcohols, ketones, sulphoxides, phosphines, phosphates, nitriles, and hydroperoxides. In certain such embodiments, the inhibitor is selected from acetylenic alcohols such as 1-ethynyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes such as 1,3,5,7-tetra-vinyltetramethyltetracyclosiloxane, low molecular weight silicone oils having methylvinyl-SiO_{1/2} groups and/or R₂vinylSiO_{1/2} end groups, e.g. divinyltetramethyldisiloxane, tetravinyldimethyldisiloxane, trialkyl cyanurates, alkyl maleates such as diallyl maleates, dimethyl maleate and diethyl maleate, alkyl fumarates such as diallyl fumarate and diethyl fumarate, organic hydroperoxides such as cumene hydroperoxide, tert-butyl hydroperoxide and pinane hydroperoxide, organic peroxides, organic sulfoxides, organic amines, diamines and amides, phosphanes and phosphites, nitriles, triazoles, diaziridines and oximes. The person of ordinary skill in the art will appreciate that the effective concentration of an inhibitor depends on its mechanism of action; accordingly, in certain embodiments as otherwise described herein, an article layer comprising a heat-activated hydrosilylation catalyst further comprises an effective amount of an inhibitor. In certain embodiments as otherwise described herein, the first layer comprises an inhibitor in an amount up to about 5,000 ppm, calculated on a weight basis. For example, in certain such embodiments, the first layer comprises an inhibitor in an amount within the range of about 10 ppm to about 5,000 ppm, or about 25 ppm to about 5,000 ppm, or about 50 ppm to about 5,000 ppm, or about 75 ppm to about 5,000 ppm, or about 100 ppm to about 5,000 ppm, or about 150 ppm to about 5,000 ppm, or about 200 ppm to about 5,000 ppm, or about 300 ppm to about 5,000 ppm, or about 400 ppm to about 5,000 ppm, or about 500 ppm to about 5,000 ppm, or about 1,000 ppm to about 5,000 ppm, or about 2,000 ppm to about 5,000, or about 3,000 ppm to about 5,000, or about 1 ppm to about 4,000 ppm, or about 1 ppm to about 3,000 ppm, or about 1 ppm to about 2,000 ppm, or about 1 ppm to about 1,000 ppm, or about 1 ppm to about 750 ppm, or about 1 ppm to about 500 ppm, or about 10 ppm to about 900 ppm, or about 10 ppm to about 800 ppm, or about 10 pm to about 700 ppm, or about 10 ppm to about 600 ppm, or about 10 ppm or about 500 ppm, or about 20 ppm to about 400 ppm, or about 30 ppm to about 300 ppm, or about 40 ppm to about 200 ppm, or about 50 ppm to about 150 ppm. In certain embodiments as otherwise described herein, the second layer comprises an inhibitor in an amount up to about 1,000 ppm, calculated on a weight basis. For example, in certain such embodiments, the first layer comprises an inhibitor in an amount within the range of about 10 ppm to about 5,000 ppm, or about 25 ppm to about 5,000 ppm, or about 50 ppm to about 5,000 ppm, or about 75 ppm to about 5,000 ppm, or about 100 ppm to about 5,000 ppm, or about 150 ppm to about 5,000 ppm, or about 200 ppm to about 5,000 ppm, or about 300 ppm to about 5,000 ppm, or about 400 ppm to about 5,000 ppm, or about 500 ppm to about 5,000 ppm, or about 1,000 ppm to about 5,000 ppm, or about 2,000 ppm to about 5,000, or about 3,000 ppm to about 5,000, or about 1 ppm to about 4,000 ppm, or about 1 ppm to about 3,000 ppm, or about 1 ppm to about 2,000 ppm, or about 1 ppm to about 1,000 ppm, or about 1 ppm to about 750 ppm, or about 1 ppm to about 500 ppm, or about 10 ppm to about 900 ppm, or about 10 ppm to about 800 ppm, or about 10 pm to about 700 ppm, or about 10 ppm to about 600 ppm, or about 10 ppm or about 500 ppm, or about 20 ppm to about 400 ppm, or about 30 ppm to about 300 ppm, or about 40 ppm to about 200 ppm, or about 50 ppm to about 150 ppm.

In certain embodiments of the compositions as otherwise described herein, one or each of the first layer and the second layer further comprises one or more particulate fillers. A variety of fillers are known in the art, such as, for example, silica or other metal oxides. For example, in certain embodiments as otherwise described herein, the first layer (e.g., comprising a cross-linkable silicone polymer) comprises a filler in an amount up to about 50 wt. %. In certain such embodiments, the first layer comprises a filler in an amount within the range of about 1 wt. % to 50 wt. %, or 2.5 wt. % to 50 wt. %, or 5 wt. % to 50 wt. %, or 10 wt. % to 50 wt. %, or 15 wt. % to 50 wt. %, or 20 wt. % to 50 wt. %, or 25 wt. % to 50 wt. %, or 30 wt. % to 50 wt. %, or 1 wt. % to 40 wt. %, or 1 wt. % to 30 wt. %, or 1 wt. % to 20 wt. %, or 10 wt. % to 30 wt. %, or 20 wt. % to 40 wt. %, or 30 wt. % to 50 wt. %. In certain such embodiments, the filler comprises silica (e.g., fumed silica). In certain such embodiments, the filler comprises silicone resin or a silsesquioxane. In certain such embodiments, the filler comprises one or more metal oxides (e.g., calcium oxide, zinc oxide, magnesium oxide).

In another example, in certain embodiments as otherwise described herein, the second layer (e.g., comprising an elastomer) comprises a filler in an amount up to about 90 wt. %. In certain such embodiments, the second layer comprises a filler in an amount within the range of about 1 wt. % to 90 wt. %, or 10 wt. % to 90 wt. %, or 20 wt. % to 90 wt. %, or 30 wt. % to 90 wt. %, or 40 wt. % to 90 wt. %, or 50 wt. % to 90 wt. %, or 60 wt. % to 90 wt. %, or 1 wt. % to 80 wt. %, or 1 wt. % to 70 wt. %, or 1 wt. % to 60 wt. %, or 1 wt. % to 50 wt. %, or 20 wt. % to 60 wt. %, or 30 wt. % to 70 wt. %, or 40 wt. % to 80 wt. %, or 50 wt. % to 90 wt. %. In certain such embodiments, the filler comprises silica (e.g., fumed silica). In certain such embodiments, the filler comprises carbon black. In certain such embodiments, the filler comprises one or more metal oxides (e.g., calcium oxide, zinc oxide, magnesium oxide). In certain such embodiments, the filler comprises one or more clays. In certain such embodiments, the filler comprises cellulose. In certain embodiments, the filler comprises one or more metal carbonates. For example, in certain such embodiments, the filler comprises magnesium carbonate. In another example, in certain such embodiments, the filler comprises calcium carbon (i.e., a whitening agent).

In certain embodiments as otherwise described herein, the first cross-linkable polymer, the first cross-linker, the first hydrosilylation catalyst, fillers, and inhibitors are present in the first layer in a combined amount of at least about 80 wt. %, or at least about 90 wt. %, or at least about 92.5 wt. %, or at least about 95 wt. %, or at least about 97.5 wt. %. In certain such embodiments, the second cross-linkable polymer, the second cross-linker, the second hydrosilylation catalyst, fillers, and inhibitors are present in the second layer in a combined amount of at least about 80 wt. %, or at least about 90 wt. %, or at least about 92.5 wt. %, or at least about 95 wt. %, or at least about 97.5 wt. %.

In certain embodiments as otherwise described herein, the first layer has a thickness within the range of about 0.1 mm to about 40 mm. For example, in certain such embodiments, the thickness of the first layer is within the range of about 0.1 mm to about 40 mm, or about 0.1 mm to about 35 mm, or about 0.1 mm to about 30 mm, or about 0.1 mm to about 25 mm, or about 0.1 mm to about 20 mm, or about 0.1 mm to about 15 mm, or about 0.1 mm to about 10 mm, or about 0.5 mm to about 40 mm, or about 1 mm to about 40 mm, or about 5 mm to about 40 mm, or about 10 mm to about 40 mm, or about 15 mm to about 40 mm, or about 20 mm to about 40 mm, or about 0.5 mm to about 30 mm, or about 0.5 mm to about 20 mm, or about 0.5 mm to about 10 mm.

In certain embodiments as otherwise described herein, the second layer has a thickness within the range of about 0.1 mm to about 40 mm. For example, in certain such embodiments, the thickness of the second layer is within the range of about 0.1 mm to about 40 mm, or about 0.1 mm to about 35 mm, or about 0.1 mm to about 30 mm, or about 0.1 mm to about 25 mm, or about 0.1 mm to about 20 mm, or about 0.1 mm to about 15 mm, or about 0.1 mm to about 10 mm, or about 0.5 mm to about 40 mm, or about 1 mm to about 40 mm, or about 5 mm to about 40 mm, or about 10 mm to about 40 mm, or about 15 mm to about 40 mm, or about 20 mm to about 40 mm, or about 0.5 mm to about 30 mm, or about 0.5 mm to about 20 mm, or about 0.5 mm to about 10 mm.

In certain embodiments as otherwise described herein, the curable article further comprises a third layer having a first side disposed adjacent the second side of the first layer or the second layer. For example, in certain embodiments as otherwise described herein, a curable article having a first layer comprising a cross-linkable silicone polymer and a second layer comprising a cross-linkable elastomer further comprises a third layer having a first side disposed adjacent the second side of the second layer. In certain embodiments as otherwise described herein, the curable article further comprises a third layer having a first side disposed adjacent the second side of the first layer or the second layer, the third layer comprising a third cross-linkable polymer comprising at least two unsaturated carbon bonds, present in the third layer in an amount within the range of about 10 wt. % to 99.9 wt. %, a third cross-linker comprising at least two silicon-hydride functional groups present in the first layer in an amount within the range of about 0.1 wt. % to 20 wt. %, and an effective amount of a first hydrosilylation catalyst.

Advantageously, the present inventors have determined that one or each of the first cross-linker and the second cross-linker can react with an unsaturated carbon bond of the first cross-linkable polymer and an unsaturated carbon bond of the second cross-linkable polymer (i.e., in a hydrosilylation reaction catalyzed by the first hydrosilylation catalyst or the second hydrosilylation catalyst). Desirably, reaction of one or each of the first cross-linker and the second cross-linker with the first cross-linkable polymer (i.e., of the first layer) and the second cross-linkable polymer (i.e., of the second layer) provides a cured multilayer article that can exhibit relatively strong interfacial adhesion.

Accordingly, another aspect of the disclosure is a method for preparing a cross-linked article including providing a curable article as otherwise described herein, and curing the curable article.

In certain embodiments as otherwise described herein, curing the curable article comprises heating the curable article to a temperature within the range of about 80° C. to about 250° C. For example, in certain such embodiments, curing the curable article comprises heating the curable article to a temperature within the range of about 80° C. to about 225° C., or about 80° C. to about 200° C., or about 80° C. to about 175° C., or about 80° C. to about 150° C., or about 90° C. to about 250° C., or about 100° C. to about 250° C., or about 125° C. to about 250° C., or about 150° C. to about 250° C., or about 90° C. to about 200° C., or about 100° C. to about 160° C.

In certain embodiments as otherwise described herein, curing the curable article comprises irradiating the curable article with light. For example, in certain such embodiments, curing the curable article comprises irradiating the curable article with light having a wavelength of less than about 400 nm. In certain such embodiments, the irradiation is conducted at room temperature.

In certain embodiments as otherwise described herein, providing the curable article comprises co-extruding the first layer and the second layer. In certain embodiments as otherwise described herein, the first layer and the second layer are co-extruded at a temperature within the range of about 5° C. to about 100° C. For example, in certain such embodiments, the co-extruding is conducted at a temperature within the range of about 5° C. to about 90° C., or about 5° C. to about 80° C., or about 5° C. to about 70° C., or about 10° C. to about 100° C., or about 15° C. to about 100° C., or about 20° C. to about 100° C., or about 10° C. to about 90° C., or about 15° C. to about 80° C.

In certain embodiments as otherwise described herein, providing the curable article comprises over-extruding the first layer over the second layer, or over-extruding the first layer over the second layer. In certain embodiments as otherwise described herein, the first layer or second layer is over-extruded at a temperature within the range of about 5° C. to about 100° C. For example, in certain such embodiments, the over-extruding is conducted at a temperature within the range of about 5° C. to about 90° C., or about 5° C. to about 80° C., or about 5° C. to about 70° C., or about 10° C. to about 100° C., or about 15° C. to about 100° C., or about 20° C. to about 100° C., or about 10° C. to about 90° C., or about 15° C. to about 80° C.

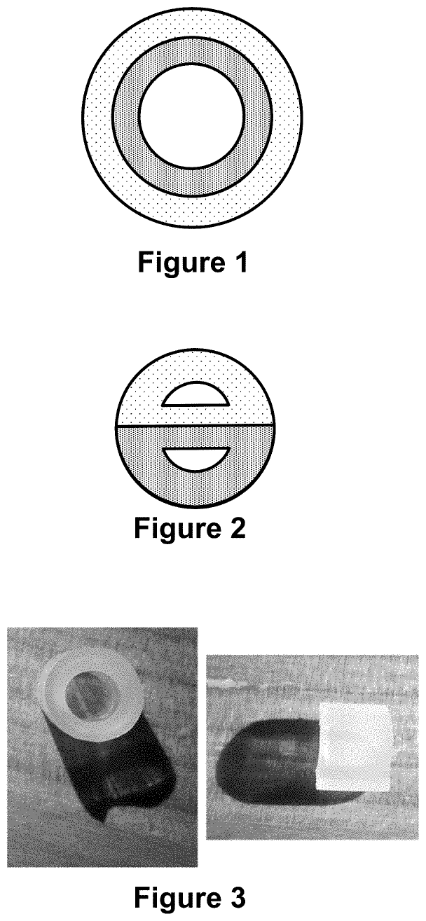

Another aspect of the disclosure is a cross-linked article, made by a method as otherwise described herein. For example, in certain embodiments as otherwise described herein, the cross-linked article is the product of curing a curable article as otherwise described herein. In certain such embodiments, the curable is provided by co-extruding or over-extruding the first layer and the second layer. In certain embodiments as otherwise described herein, the cross-linked article is in the form of a tube. For example, in certain such embodiments, the second side of the first layer or the second layer defines a central lumen of the tube (e.g., as shown in schematic cross-sectional view in FIG. 1). In another example, the second side of each of the first layer and the second layer define a lumen of one chamber of a dual-chamber tube (e.g., as shown in schematic cross-sectional view in FIG. 2).

### EXAMPLES

The Examples that follow are illustrative of specific embodiments of the invention, and various uses thereof. They are set forth for explanatory purposes only, and are not to be taken as limiting the invention.

### Example 1. Cross-Linker Comparison

Interfacial adhesion of a silicone layer and an EPDM layer, each layer comprising one or both of a polysiloxane with silicon-hydride functionality and a C₈ pendant group and a polysiloxane with silicon-hydride functionality and a C₁ pendant group, was tested (see Table 2, below).

| | | Layer 1 | | Layer 2 |
|---|---|---|---|---|
| | | Cross- | | Cross- |
| | | Linker | Layer | Linker |
| | Layer 1 | Pendant | 2 | Pendant |
| Article | Polymer | Group | Polymer | Group |
| 1 | Vinyl Silicone | C₁ | EPDM Rubber | C₁ |
| 2 | Vinyl Silicone | C₁ | EPDM Rubber | C₈ |
| 3 | Vinyl Silicone | C₈ | EPDM Rubber | C₁ |
| 4 | Vinyl Silicone | C₈ | EPDM Rubber | C₈ |
| 5 | Vinyl Silicone | C₁, C₈ | EPDM Rubber | C₁ |
| 6 | Vinyl Silicone | C₁, C₈ | EPDM Rubber | C₈ |

Each of cured articles 1-6 exhibited good interfacial adhesion. Notably, interfacial adhesion of article 1 was particularly strong.

1-98. (canceled)

99. A curable article comprising
a first layer having a first side and an opposed second side, the first layer comprising
a first cross-linkable polymer comprising at least about two unsaturated carbon bonds, present in the first layer in an amount within the range of about 10 wt. % to about 99.9 wt. %,
a first cross-linker comprising at least about two silicon-hydride functional groups, present in the first layer in an amount within the range of 0.1 wt. % to 20 wt. %, and
an effective amount of a first hydrosilylation catalyst; and
a second layer having a first side disposed in contact with the first side of the first layer and an opposed second side, the second layer comprising
a second cross-linkable polymer comprising at least about two unsaturated carbon bonds, present in the second layer in an amount within the range of 10 wt. % to 99.9 wt. %;
a second cross-linker comprising at least about two silicon-hydride functional groups, present in an amount within the range of 0.1 wt. % to 20 wt. %; and
an effective amount of a second hydrosilylation catalyst,
the second layer not including a substantial amount of the first cross-linkable polymer.

100. The article of claim 99, wherein each unsaturated carbon bond is a carbon-carbon double bond.

101. The article of claim 99, wherein the first cross-linkable polymer is a polysiloxane.

102. The article of claim 9901, wherein the first cross-linkable polymer is a cross-linkable fluorinated polyether having a fluorinated polyether block having at least two ends, and at least about two unsaturated carbon bonds.

103. The article of claim 99, wherein the first cross-linkable polymer is a cross-linkable fluorinated polyether having a fluorinated polyether block having at least two ends, and at least about two unsaturated carbon bonds.

104. The article of claim 99, wherein the first cross-linkable polymer is present in the first layer in an amount within the range of 20 wt. % to 98 wt. %.

105. The article of claim 99, wherein the second cross-linkable polymer is a thermosetting polymer having at least about two unsaturated carbon bonds.

106. The article of claim 99, wherein the second cross-linkable polymer is an elastomer polymer having at least about two unsaturated carbon bonds.

107. The article of claim 99, wherein the second cross-linkable polymer is an ethylene propylene diene rubber, a polybutadiene rubber, a butyl rubber, a nitrile rubber, or a polyisoprene rubber.

108. The article of claim 99, wherein the second cross-linkable polymer is a rubber having a first terminal group and a second terminal group, wherein the first terminal group and the second terminal group each comprise a C₁-C₁₂ hydrocarbon comprising an alkenyl group.

109. The article of claim 99, wherein the second cross-linkable polymer is a cross-linkable fluorinated polyether having a fluorinated polyether block having at least two ends, and at least about two unsaturated carbon bonds.

110. The article of claim 99, wherein the second cross-linkable polymer does not include substantial amounts of a polysiloxane.

111. The article of claim 99, wherein one or each of the first cross-linker and the second cross-linker comprises about two silicon-hydride functional groups.

112. The article of claim 99, wherein one or each of the first cross-linker and the second cross-linker is a polysiloxane.

113. The article of claim 99, wherein the first cross-linker is the same as the second cross-linker.

114. The article claim 99, wherein
the first cross-linkable polymer is a polysiloxane, present in the first layer in an amount within the range of 50 wt. % to 99.9 wt. %; and
the second cross-linkable polymer is an elastomer, present in the second layer in an amount within the range of 10 wt. % to 99.9 wt. %.

115. The article of claim 99, wherein
the first cross-linker is present in the first layer in an amount within the range of 0.1 wt. % to 10 wt. %;
the second cross-linker is present in the second layer in an amount within the range of 1 wt. % to 10 wt. %; and
the first cross-linker and the second cross linker each independently comprise a compound of Formula III: 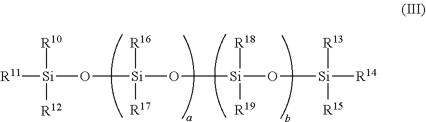
wherein:
each of R¹⁰, R¹¹, R¹², R¹³, R¹⁴, R¹⁵, R¹⁶, R¹⁷, R¹⁸, and R¹⁹ is independently hydrogen, C₁-C₆₀ hydrocarbon, or 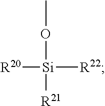
in which each of R²¹, R²², and R²³ is independently hydrogen or C₁-C₁₂ hydrocarbon (e.g., C₁-C₁₂ alkyl, or C₄-C₁₂ cycloalkyl, or C₆-C₁₂ aryl); and
each of a and b is independently 0-1,000.

116. The article of claim 99, wherein one or each of the first hydrosilylation catalyst and the second hydrosilylation catalyst comprises titanium, iron, manganese, cobalt, copper, zinc, molybdenum, ruthenium, rhodium, palladium, tin, ytterbium, rhenium, iridium, or platinum.

117. The article of claim 99, wherein
the first cross-linkable polymer, the first cross-linker, the first hydrosilylation catalyst, and any fillers and/or inhibitors present are present in the first layer in a combined amount of at least 90 wt. % of the first layer; and
the second cross-linkable polymer, the second cross-linker, the second hydrosilylation catalyst, and any fillers and/or inhibitors present are present in the second layer in a combined of at least 90 wt. % of the second layer.

118. The article of claim 99, wherein the thickness of the first layer is within the range of about 0.1 mm to about 40 mm.

119. The article of claim 99, wherein the thickness of the second layer is within the range of about 0.1 mm to about 40 mm.

120. A method for preparing a cross-linked article, the method comprising providing a curable article according to claim 99, and curing the curable article.

121. A cross-linked article that is the cured product of the curable article of claim 99.

122. The cross-linked article of claim 121 in the form of a tube, wherein the second side of the first layer or the second layer defines a central lumen of the tube.

123. The cross-linked article of claim 121 in the form of a dual-chambered tube, wherein the second side of each of the first layer and the second layer define a lumen of one chamber of the tube.
